(19) United States
(12) Patent Application Publication
(10) Pub. No.: US 2008/0001846 A1
(43) Pub. Date: Jan. 3, 2008

(54) Method for Evaluating Reflector Answer Signals of a System for Recognizing the Occupancy of a Seat

(75) Inventors: Klaus Hofbeck, Neumarkt (DE); Birgit Rosel, Regensburg (DE); Arnd Stielow, Regensburg (DE); Roland Wagner, Donaustauf (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/663,691

(22) PCT Filed: Aug. 11, 2005
(86) PCT No.: PCT/EP05/53963

§ 371 Date: Apr. 16, 2007

(30) Foreign Application Priority Data
Sep. 23, 2004 (DE) 102004046189.9

(51) Int. Cl. B60R 21/01; H01Q 21/00

(52) U.S. Cl. 343/893; 180/271

(57) ABSTRACT

A method determines reference values that are used for calculating the damping thickness d in a seat occupancy recognition system. Several reflector answer empty values are initially measured for an unoccupied seat, the empty values being, for example, allocated, respectively to a predetermined seat position of the seat and a specific reception antenna. A reflector answer reference value allocated to a seat reflector or the seat is determined with the aid of a predetermined algorithm and from the measured reflector answer empty values.

The present invention relates to a method for evaluating the reflector answer signals of a system for recognizing the occupancy of a seat, in particular in a motor vehicle, with the system having at least one base station with a transmitter for sending signals and a receiver for receiving reflector answer signals reflected to at least one reflector allocated to the seat for recognizing the occupancy of a seat.

A plurality of different systems for recognizing the occupancy of a seat are known at present, these are however not discussed in further detail here. A novel system for recognizing the occupancy of a seat, which has not yet been published and developed by the applicant at present, is the so-called HOBBIT system (=Human-Observation-by-Beam-Interference-Technology). The HOBBIT system consists of a central base station and individual reflectors in the seat for recognizing the occupancy of a seat in each instance. The HOBBIT system uses the diffraction, the attenuation, and/or the reflection of high-frequency signals (for example, 2.45 GHz waves) in order to recognize the occupancy of a seat with persons. In the case of the HOBBIT system, an area of all the seats to be monitored within a passenger cell of a motor vehicle is illuminated with the high-frequency electromagnetic wave field. To this end, the base station transmits signals which hit the reflectors, whereupon they are modulated and reflected and received in turn by the base station.

The reflector answers obtained in this way are evaluated with regard to their level. To this end, a so-called attenuation thickness d is determined in general for each reflector of the seat, which represents a measurement for the attenuation through a material with a predetermined thickness d. The attenuation thickness d refers for example to the logarithm from the ratio of the received level of the answer signal and the sent level or from the ratio of the received level of the answer signal and to an allocated reference level or reference value, which is referred to below as the reference value of the answer signal. The value of the attenuation thickness d is higher, the lower the level of the reflected signal that is received by the base station. Therefore, the attenuation thickness d is a measurement for the occupancy of a seat so that it is possible to conclude the occupancy of a seat with a person or an object from the attenuation thickness d.

For the case of determining the attenuation thickness d by using the reference values of answer signals, the reference values have a decisive importance in the sense that incorrect attenuation thicknesses d are determined and in some circumstances an incorrect classification of the occupancy of a seat is carried out in each instance in the case of reference values that have not been determined directly.

However, a general problem consists in the fact that in the unoccupied seat, certain reference values can vary with the seat position of a seat, because a vertical and/or a horizontal change in the seat position of a seat as well as a change in the backrests of the seat, change the wave field and/or individual reflectors provided in the seat to the base station. A reference value of a seat that is independent of the seat position of the seat can thus be determined too inaccurately in some seat positions and can thus trigger an incorrect classification.

The object underlying the present invention is thus to create a method, which guarantees an evaluation of the reflector answer signals by means of reliably determined reference values in a simple and reliable manner.

This object is achieved in accordance with the invention by means of the method with the features of claim 1.

The idea underlying the present invention consists in the fact that, in order to evaluate the answer signals of reflectors of the system for recognizing the occupancy of a seat, a number of reflector answer empty values that have been allocated to a predetermined seat position of the seat in each instance are measured in advance for the unoccupied seat, with at least one reflector answer reference value allocated to a seat being determined from these previously measured reflector answer empty values, with the aid of a predetermined algorithm. In the classification operation, the reflector answer signals reflected by the at least one reflector are received by the receiver, it being possible that the attenuation thickness d is calculated by using the at least one previously determined reflector answer reference value.

The present invention is thus advantageous compared with the prior art such that, for a predetermined seat position of a seat, correspondingly allocated reflector answer empty values are measured, which form the basis for a calculation of at least one reference value of the seat. In this way, the individual seat positions are also included in the algorithm for the calculation of at least one reference value so that even in the case of different seat positions of a seat, a reliable evaluation of the reflector answer signals and in this way a reliable classification can be guaranteed. In this way, a reference value can be allocated to the seat, said reference value representing an unreliable reference independent of the actual seat position, and ensuring a long signal distance between an unoccupied seat and an occupied seat. As a result, the system becomes less sensitive to an incorrect classification.

In addition, the present invention is also advantageous in that an allocated reference value only has to be determined once for each reflector of the seat. This can take place within the framework of the development for a type of motor vehicle or possibly a predetermined seat design. For this reason, the complex and costly individual determination of a reference value is no longer applicable for each individual motor vehicle at the end of the production loop. In addition, a determination of the momentary accurate seat position is also not required for a determination of the occupancy of the seat because the reference value is determined independent of the seat position.

Advantageous improvements and embodiments of the method specified in claim 1 are found in the subclaims.

In accordance with a preferred development, an allocated reflector answer empty value can be measured in each instance for a predetermined seat position, which preferably consists of a horizontal position, a vertical position, and/or a tilting of the backrest of the seat. For example, the reflector answer empty values are measured both in the top and in the bottom vertical seat position of the seat across all the horizontal seat positions of the seat, but preferably separately for each individual reflector of a seat. Subsequently, the at least one reflector answer reference value is determined as an average value, a weighted average value, a minimum value, a minimum value in consideration of the standard deviation, or the like, of the measured reflector answer empty values. In this way a common reflector answer reference value can be determined for the seat or an individual reflector answer reference value can be determined and allocated for each reflector of the seat. A reference value determined in this way advantageously enables a quick and simple evaluation because only a single reference value is used for each reflector.

In accordance with a further preferred exemplary embodiment, a reflector answer reference value is determined for each possible seat position of a seat in each instance, this being advantageous for each individual reflector. The individually determined reflector answer reference values, which are for example allocated to each reflector and/or each possible seat position, are stored in a storage facility in a reference value table for example.

In the receiver of the base station, provision is preferably made for at least two reception antennas for a so-called antenna diversity mode, with the at least two reception antennas being at a defined distance from each other, for example, approximately half the wave length of the reflector answer signals. In doing so, the measurements of the reflector answer empty values on the at least two reception antennas for the prior determination of the at least one reflector answer reference value are included in the predetermined algorithm.

In accordance with a further preferred exemplary embodiment, a re-calibration of the at least one determined reflector answer reference value can be carried out automatically or manually.

An optimal adjustment of the reference values to the momentary seat position is enabled by determining a number of reference values, whereby a higher accuracy of the determination of the attenuation thickness d is guaranteed in.

The invention is described in more detail below with reference to the exemplary embodiments specified in the schematic figures of the drawing, in which;

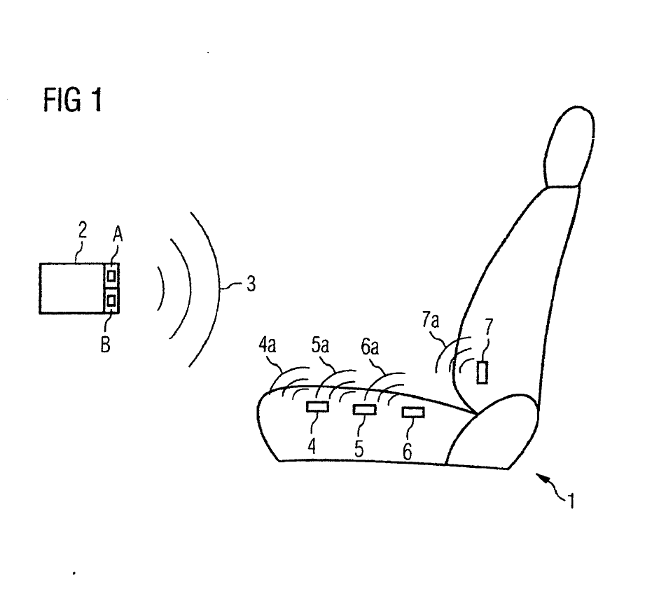

FIG. 1 shows a schematic representation of a system for recognizing the occupancy of a seat in accordance with an exemplary embodiment of the present invention;

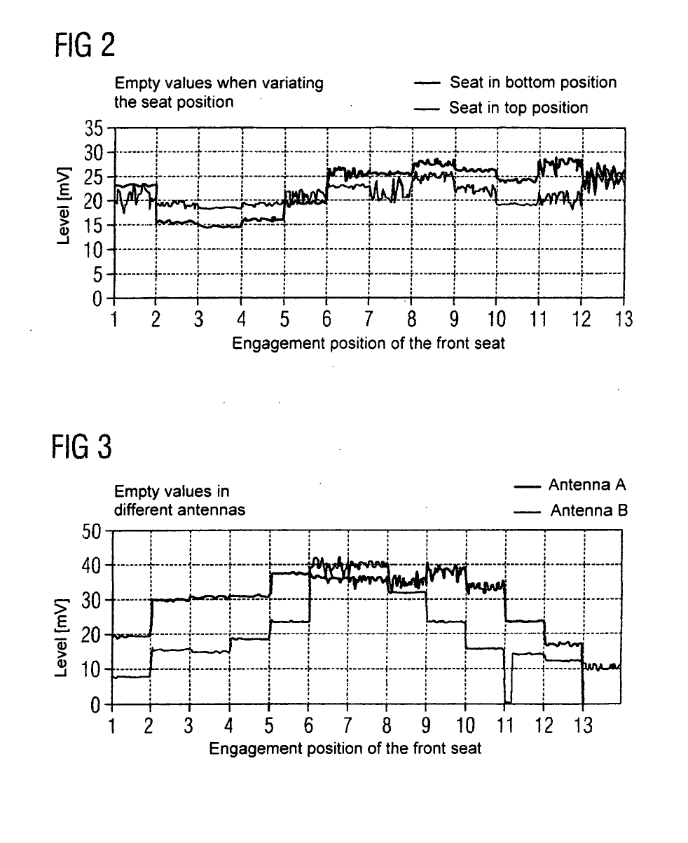

FIG. 2 shows a graphical representation of the dependency of the level of the reflector answer empty values on the seat position; and

FIG. 3 shows a graphical representation of the dependency of the level of the reflector answer empty values on the reception antenna position.

In the figures in the drawings, the same reference characters refer to the same or functionally comparable components in so far as it is not stated to the contrary.

FIG. 1 shows a schematic representation of a system for recognizing the occupancy of a seat by using high-frequency signals. A seat 1 is illuminated by means of a HF transmitter in a base station 2 with a high-frequency electromagnetic wave field 3. The seat 1 has a plurality of reflectors 4, 5, 6, 7 at different points, which reflect the HF wave field 3. The reflectors 4, 5, 6, 7 can send the reflected HF wave fields 4a, 5a, 6a, 7a back modulated. The reflected HF wave fields 4a, 5a, 6a, 7a are received by a HF receiver in the base station 2. Because of this, it is possible to allocate the reflected HF wave fields 4a, 5a, 6a, 7a to the individual reflectors 4, 5, 6, 7.

If the HOBBIT system is operated with an unoccupied seat 1, as shown in FIG. 1, the electromagnetic waves 3 sent from the base station 2 almost reach the reflectors 4, 5, 6 and 7 in an unattenuated manner and/or in an only slightly attenuated manner. The reflector answer signals received in this way represent the so-called empty value, i.e. the reflector answers of an unoccupied seat.

In accordance with the invention, one or a number of reference values are determined beforehand from the previously measured empty values and, if required, are stored in a suitable storage facility in reference value tables and allocated to the individual reflectors and/or the individual seat positions. This is explained in more detail below with reference to the FIGS. 2 and 3.

FIG. 2 shows a graphical representation of the dependency of the level of the reflector answer empty values received at the base station 2 on the respective seat position of the seat 1. In doing so, the individual horizontal engagement positions of the seat 1, for instance the front seat, are for example shown on the x-coordinate and identified with the engagement seat position numbers 1 to 13. In this process, 1 corresponds to the horizontal front seat position and 13 to the horizontal rear seat position. The thicker measurement curve shown in FIG. 2 identifies a measurement of the empty value level in the bottom vertical seat position and the thinner measurement curve shown identifies the empty value level in the vertical top seat position of the seat.

It is thus obvious from FIG. 2 that the level of the received empty values depends on the respective seat position of the seat 1, with only the vertical and the horizontal variation of a seat 1 being taken into account in FIG. 2. However, it is very clear to a person skilled in the art that additional changes in the position of a seat 1, for example a change in the tilting of the backrest, the seat surface and/or other individual parts of a seat can likewise also be taken into account and have hence been included in the underlying idea of the invention.

A variation in the empty value level in the case of a change in the seat position is essentially caused as a result of the fact that both the angle and the distance of the individual reflectors 4, 5, 6, 7 to the base station 2 as well as the propagation conditions change with the respective seat position so that the level of the respective empty value fluctuates accordingly.

On the basis of the change in the empty value of the reflector answer as a function of the seat position of a seat on the basis of the different angles of incidence, the distance from the base station as well as the different propagation conditions by changing the seat position of a seat, in accordance with a first preferred exemplary embodiment, a reference value is determined for each individual reflector 4, 5, 6, 7 of a seat 1 from the measured empty values when varying the seat position both in the bottom vertical seat positions of the seat 1 and in the top vertical seat position of the seat 1 by way of all the possible horizontal seat positions of a seat 1 as is shown graphically by way of example in FIG. 2 for a reflector. It is possible for instance to define a reference value that has been allocated to a reflector of a seat 1 from the individual empty values measured from the measurement curve in FIG. 2, as a minimum value or an average value of the measured empty values. It is also obvious to a person skilled in the art that different algorithms are possible in said case in order to calculate the reference value from the measured empty values, for example, an additional consideration of the standard deviations, variations, or the like.

Empty value measurements when varying the seat position in accordance with FIG. 2 are preferably carried out and recorded for each reflector 4, 5, 6, 7 from FIG. 1, as was already explained above. A characteristic reference value from the measured empty values according to a predetermined algorithm is determined for and allocated to each reflector 4, 5, 6, 7. A specific reference value determined in accordance with the said exemplary embodiment enables a quick and simple evaluation of the received reflector answer signals during a normal operation of the system, because only a single reference value is used for each reflector 4, 5, 6, 7.

According to a further preferred exemplary embodiment, a common reference value can in turn be calculated for a seat 1 according to a predetermined algorithm from the reference values assigned to the individual reflectors 4, 5, 6, 7 so that in the case of an evaluation operation for the evaluation of the reflector answer signals for classifying the occupancy of a seat, even less and more rapidly implementable computation efforts are guaranteed. Naturally only certain reflectors can be combined with one another such that a common reference value is assigned thereto.

According to a further preferred exemplary embodiment, previously determined reference values are preferably assigned to the predetermined seat positions or to all the possible seat positions. In doing so, the previously measured empty values of the individual seat positions of a seat 1, as shown in FIG. 2, are measured and stored for example in reference value tables in a suitable storage facility. During the seat occupancy recognition operation of the system, sensors mounted on the seat 1 preferably additionally record the respective seat position and assign the corresponding reference value from the reference table for evaluating the received reflector answer signals to said seat position. Because of the determination of a plurality of reference values as a function of the seat position of a seat 1, an optimal adjustment of the reference values to the seat position of a seat is made possible in this case, whereby the determination of the attenuation thickness d can be achieved in a more accurate manner.

In a similar manner to the first exemplary embodiment, in the case of the specific seat position, all the possible changes, i.e. the horizontal and the vertical seat positions of a seat as well as a tilting of the backrest, the seat surface or the like can be taken into account in the case of the measurements of the empty values.

FIG. 3 shows a graphical representation of the level of measured empty values when measuring by means of two reception antennas A and B arranged in different seat positions when varying the horizontal engagement position of a seat 1, for example, of the front seat.

With a wave field 4a, 5a, 6a, 7a, locations exist at which the wave field 4a, 5a, 6a, 7a has a minimum value and locations exist at which the wave field 4a, 5a, 6a, 7a correspondingly has a maximum value. If the transmitter and/or the receiver of base station 2 is preferably equipped with two or more transmission antennas or reception antennas, which are at a predetermined distance from one another, for example, at a distance of half the wave length of the reflected high-frequency waves, the maximum value of both the reflector answers can be selected at each location and in the case of each measured value. This is generally referred to as so-called antenna diversity.

In the graphical representation shown in FIG. 3, the reflector answers measured by the two reception antennas A and B, which are at a distance of half the wave length of the reflector answer signals are shown, i.e. the level of the empty values in the case of different horizontal engagement positions of a seat 1. In order to calculate one or a number of reference values for the seat 1 and/or for each reflector of the seat 1, the results of the empty value level measurements in the case of different seat positions as well as the level measurements with the different reception antennas can be combined with one another with the aid in turn of a predetermined algorithm and evaluated jointly.

A possible algorithm and/or an advantageous procedure for determining a reference value allocated to the seat 1 from the measurements of the empty value level is explained in more detail below purely by way of example in accordance with FIGS. 2 and 3.

An empty value measurement preferably takes place first over all the possible horizontal seat positions of seat 1 to 13, with a seat 1 then initially being located in the top vertical seat position. In addition, the empty value measurement is then carried out by means of an antenna diversity mode, i.e. with the two antennas A and B at a distance from each other in an advantageous manner as is shown in FIG. 3. At each seat position 1 to 13, the maximum value is for example selected from the two measured reflector answers at the antennas A and B and used again. The maximum level curve is herewith obtained for the individual horizontal seat positions 1 to 13 with the top vertical seat position of a seat 1.

In an analogous manner, empty value measurements are carried out over all horizontal seat positions 1 to 13 in the bottom vertical seat position of a seat 1 using the two antennas A and B, with the maximum value being selected from the measured reflector answers at each measuring point for instance.

Therefore, it is likewise also possible to obtain the maximum level curve for the individual horizontal seat positions of a seat 1 to 13 in the bottom vertical seat position. Subsequently, the empty value curve of the empty values with a horizontal variation in the seat position is advantageously determined from these two maximum level curves at each identical measuring point according to a predetermined algorithm, by an average value formation or a selection of the minimum value of the two level curves for instance.

In addition, an empty value measurement is carried out for example over all the vertical seat positions in the case of a predetermined fixed horizontal seat position of a seat 1 for instance with the above-explained antenna diversity, i.e. with a measurement at the two antennas A and B. Analogous to the above-mentioned maximum level curves, the maximum value is in turn selected from the two measured reflector answers at each measuring point by antennas A and B, the maximum level curve of the empty values is determined in the case of a variation in the seat position of a seat in the vertical direction with a fixed horizontal position of a seat 1.

In conclusion, for the viewed reflector, an assigned reference value can be defined by the absolute minimum value of the above-described calculated empty value curve for a variation of the seat position in the horizontal direction and of the maximum level curve for the empty values when varying the seat position in a vertical direction.

These calculations carried out beforehand can be carried out for instance in a central control facility connected to the base station 2. As already explained above, the central control facility is preferably connected to an allocated control facility in order to store the previously determined reference values in suitable reference tables for example.

The above-explained exemplary method for determining a reference value allocated to a specific reflector is only understood as being exemplary. From the individual measurement data of the different empty value measurements of a number of antennas in the case of the different seat positions of a seat 1, any suitable algorithms can be used in order to allocate a suitable reference value to the respective reflectors and/or the seat.

For example, a reference value which is independent of the respective seat position of the seat 1 can be determined for each reflector from the individual measurement values, which ensures a large signal distance between an unoccupied and an occupied seat condition. The system herewith becomes more insensitive in respect of incorrect classifications.

From the reference values calculated in each case and the reflector answer signals received by the receiver, it is for example possible that in the seat occupancy recognition operation of the system, the attenuation thickness d be calculated according to the following formula:

$$Attenuation thickness d = - 1 n \frac{attenuated value}{reference value} , \qquad ( 1 )$$

with the “attenuated value” corresponding to the level of the reflector answers received at the base station 2.

The attenuation thickness d calculated according to the above-mentioned formula, which is for example determined individually for each reflector, is subsequently used to classify the person sitting on a seat 1. The value of a attenuation thickness d is greater, the lower the level that is received at the base station 2, i.e. the seat is for example occupied by an adult. On the other hand, the value of the attenuation thickness d is lower, the greater the level that is received at the base station 2. This means that the seat is an unoccupied seat. As a function of such a classification of the occupancy of a seat, corresponding safety systems of the motor vehicle can be used for example, a belt tensioning device or an airbag for instance that is activated in the event of an accident.

In this way, the present invention creates a method for evaluating the reflector answer signals of a seat occupancy recognition system by determining the reliable reference values beforehand. In an advantageous manner, it is necessary that for each reflector, an allocated reference value only has to be determined in the course of the development for a predetermined type of vehicle or a predetermined type of seat.

After re-building a motor vehicle, for example the installation of a new seat or in the case of modifications to the existing seat, a recalibration of the reference value or the reference values can also be advantageous. In this way, a double radar system located in a motor vehicle is for example used in order to guarantee that a seat that has to be recalibrated is not occupied during an automatic recalibration.

A recalibration of this type can be carried out as follows. The seat to be recalibrated is engaged in a defined seat position and one or a number of empty value measurements are preferably carried out automatically in the said defined position of a seat. Subsequently the seat is automatically moved slightly, in the horizontal or vertical direction for instance, with empty value measurements in turn being implemented.

Subsequently, the measured empty values from the empty value measurements are compared with the corresponding empty values from the measurements that were carried out beforehand, with a new reference value being defined and stored if required depending on the deviation.

Such a recalibration of the seat can preferably be carried out automatically, but it can also be carried out manually.

Although the present invention was described on the basis of preferred exemplary embodiments of the invention, it is not limited to these, but can be modified in many ways.

For example, different suitable algorithms can be used to calculate the reference value or reference values from the specific empty value measurements. For example, a reference value is determined for all the reflectors in each case, with only the minimum value of all the reference values being calculated as the common reference value for the seat. Other statistical approaches for forming a common reference value for all the reflectors such as for example forming the average value of the individual reference values or calculating the minimum value by considering the standard deviation are naturally also conceivable.

1-10. (canceled)

11. A method for evaluating reflector answer signals of a system for recognizing an occupancy of a seat, the system having at least one base station with a transmitter for sending signals and a receiver for receiving reflector answer signals reflected by at least one reflector allocated to the seat for recognizing the occupancy of the seat, which comprises the steps of:
performing measurements for determining a number of reflector answer empty values that have been allocated in each instance to a predetermined seat position of the seat of an unoccupied seat;
determining at least one reflector answer reference value allocated to the seat from the reflector answer empty values measured beforehand with an aid of a predetermined algorithm resulting in at least one previously determined reflector answer reference value;
receiving the reflector answer signals, reflected by the at least one reflector, in the receiver of the base station; and
calculating an attenuation thickness from the reflector answer signals received and the at least one previously determined reflector answer reference value for recognizing the occupancy of the seat.

12. The method according to claim 11, which further comprises for a plurality of predetermined seat positions, each varying with respect to at least one of a horizontal seat position, a vertical seat position, a tilting of a backrest, a tilting of a seat surface and a tilting of an additional part of the seat, measuring a reflector answer empty value allocated to the reflector in each instance.

13. The method according to claim 11, which further comprises measuring the reflector answer empty values both in a top vertical seat position and in a bottom vertical seat position of the seat across all horizontal seat positions of the seat.

14. The method according to claim 11, which further comprises determining for each of the reflector answer empty values allocated to the reflector as one of an average value, a weighted average value, a minimum value and a minimum value in consideration of a standard deviation of a correspondingly measured reflector answer empty values.

15. The method according to claim 11, which further comprises for a plurality of predetermined seat positions, varying with respect to at least one of a horizontal position, a vertical position, a tilting of a backrest, a tilting of a seat surface and a tilting of an additional part of the seat, determining a reflector answer empty value in each instance.

16. The method according to claim 11, which further comprises determining a reflector answer reference value for each reflector of the seat.

17. The method according to claim 16, which further comprises determining a common reflector answer reference value for the seat from the individual reflector answer reference values of the individual reflectors with an aid of a further predetermined algorithm.

18. The method according to claim 11, which further comprises providing a storage facility for storing the at least one reflector answer reference value.

19. The method according to claim 11, which further comprises providing at least one of at least two transmission antennas and at least two reception antennas in one of the transmitter and the receiver of the base station, the antennas being at a defined distance from each other, with individual measurements or the at least two transmission antennas and/or the at least two reception antennas being taken into account in the predetermined algorithm to assist in determining the at least one reflector answer reference value.

20. The method according to claim 11, which further comprises carrying out a recalibration of the at least one reflector answer reference value one of automatically and manually.

21. The method according to claim 11, which further comprises providing the seat to be a motor vehicle seat.

22. The method according to claim 19, which further comprises setting the defined distance to be approximately half a wave length of the reflector answer signals.

23. The method according to claim 18, which further comprises storing the at least one reflector answer reference value in a reference value table.
